(19) United States
(12) Patent Application Publication
(10) Pub. No.: US 2009/0268267 A1
(43) Pub. Date: Oct. 29, 2009

(54) HOLOGRAM RECORDING CARRIER AND HOLOGRAM APPARATUS

(76) Inventor: Masakazu Ogasawara, Tsurugashima-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/441,831

(22) PCT Filed: Oct. 11, 2006
(86) PCT No.: PCT/JP2006/320329

§ 371 Date: Mar. 18, 2009

(51) Int. Cl. G03H 1/26

(52) U.S. Cl. 359/3; 359/22

(57) ABSTRACT

A hologram recording carrier that information is recorded into or reproduced from by irradiating light, comprises a hologram recording layer to store an optical interference pattern by coherent reference light and signal light as a hologram therein; and a servo layer laid on top of the hologram recording layer in a film thickness direction, multiple marks being recorded beforehand on the servo layer. The multiple marks form lines as multiple mark rows extending in a direction parallel to a relative movement direction of a light spot of a hologram recording beam irradiated on the hologram recording carrier.

### TECHNICAL FIELD

The present invention relates to a hologram recording carrier having a hologram recording layer that information can be recorded into or reproduced from by irradiating a light beam, such as an optical disc or an optical card, and a hologram apparatus.

### BACKGROUND ART

Holograms that can record two-dimensional data at high density are attracting attention for high density information recording. The characteristic of the holograms consists in recording wavefronts of light carrying record information volumetrically as change in the index of refraction in a recording medium made of photosensitive material such as photorefractive material. Performing multiplex recording into a hologram recording carrier can dramatically increase the recording capacity. The multiplex recording includes angle multiplexing and phase encoding multiplexing, and in a multiplexed hologram area, information can be multiplex recorded by changing the incident angles or phases of interfering light waves.

Meanwhile, there are being developed optical information recording apparatuses recording information at ultrahigh densities using hologram recording carriers as discs. In order to record an interference pattern of hologram, moderate exposure time and energy with a recording medium and writing light being stationary relative to each other are needed, and hence the conventional art provides a method to continue exposure accurately at a recording position in a moving recording medium.

Among conventional hologram recording carriers is one on whose surface, markers are arranged as position information (refer to Japanese Patent Application Laid-Open Publication No. 2005-302149 (Reference 1)). However, in Reference 1 no specific shape of positioning marks is shown.

Further, among conventional hologram recording carriers is one having positioning marks therein (refer to Japanese Patent Application Laid-Open Publication No. 2005-228416 (Reference 2)) and one having regions for a hologram recording beam to move in a radial direction in (refer to Japanese Patent Application Laid-Open Publication No. 2005-203070 (Reference 3)). However, in References 2, 3, the shapes of tracks, address areas, and positioning marks are not definitely shown.

### DISCLOSURE OF THE INVENTION

### Problem to be Solved by the Invention

The diameter of alight spot on a track in a conventional hologram recording carrier is set to be reduced down to a value determined by the wavelength of light and the numerical aperture (NA) of an objective lens (a so-called diffraction limit, e.g., 0.82λ/NA, where λ=wavelength). In this conventional example, a servo beam is set to converge in diameter to the diffraction limit, and hence there are restrictions on the shapes of address and position information markers.

Conventionally, when performing hologram recording or reproduction multiple times, since the unit amount of bit data to be written in one hologram recording step is large, control is complex which includes a search on a per hologram basis to search for a data already recorded area, and in addition, a complex servo detection system is needed for position control of the minute light spot.

Accordingly, an object of the present invention is to provide a hologram recording carrier and hologram apparatus that allows multiple times of hologram recording to be quickly performed and enables stable recording or reproduction to be readily performed.

### Means for Solving the Problem

According to claim 1, there is provided a hologram recording carrier that information is recorded into or reproduced from by irradiating light, comprising a hologram recording layer to store an optical interference pattern by a coherent hologram recording beam as a hologram therein; and a servo layer laid on top of the hologram recording layer in a film thickness direction, multiple marks being recorded beforehand on the servo layer. The multiple marks form lines as multiple mark rows extending in a direction parallel to a relative movement direction of a light spot of the hologram recording beam irradiated on the hologram recording carrier. By this means, addresses of angle multiplexed hologram groups (books) are defined in a hologram recording carrier of an angle multiplexing scheme, and at the same time, marks for identifying areas to record a book are set in the hologram recording carrier. The use of the mark rows makes accurate positioning by a simple servo detection system possible.

Each of the marks preferably has a shape longer in a direction perpendicular to the relative movement direction of the light spot than in the direction parallel thereto. For example, with a hologram recording carrier in a disc shape, by making the marks longer in a radial direction, the marks can be detected even if eccentricity or the like occurs in the disc.

Positioning marks having a shape different from that of the marks are preferably placed between ones of the mark rows in line in the direction parallel to the relative movement direction of the light spot at intervals equal to a recording interval of a plurality of the holograms. For example, an address region of the marks and the positioning mark are different in mark shape and hence easy to distinguish.

An interval of adjacent ones of the mark rows in a direction perpendicular to the relative movement direction of the light spot is preferably equal to a recording interval of a plurality of the holograms.

It is preferable that between adjacent ones of the mark rows in a direction perpendicular to the relative movement direction of the light spot, mark rows each formed of multiple marks forming a line in the perpendicular direction are respectively placed, along which the light spot relatively moves.

An identifying mark is preferably placed at an end of the mark row formed of multiple marks forming a line in the perpendicular direction between adjacent ones of the mark rows in the perpendicular direction. There are marks indicating radial movement areas, and hence radial movement can be performed accurately.

According to claim 7, there is provided a hologram apparatus for a hologram recording carrier that hologram information is recorded into or reproduced from by irradiating light and has a hologram recording layer to store an optical interference pattern by a coherent hologram recording beam as a hologram therein, and a servo layer laid on top of the hologram recording layer in a film thickness direction, multiple marks being recorded beforehand on the servo layer, wherein the multiple marks form lines as multiple mark rows extending in a direction parallel to a relative movement direction of a light spot of the hologram recording beam irradiated on the hologram recording carrier. The hologram apparatus performs servo control to converge a light spot on the mark on the servo layer and read information of the mark from the return light, thereby making the light spots follow movement of the hologram recording carrier and at the same time, controls a relative position relationship between the hologram recording carrier and the light spots.

The light spot on the servo layer preferably has a shape longer in a direction perpendicular to the relative movement direction of the light spot than in the direction parallel thereto. For example, with a hologram recording carrier in a disc shape, by making the light spot longer in a radial direction, the address marks or the positioning marks can be detected even if eccentricity or the like occurs in the disc.

### BRIEF DESCRIPTION OF DRAWINGS

FIG. 1 is a plan view showing a hologram recording carrier according to an embodiment of the present invention;

FIG. 2 is a schematic fragmentary sectional view showing the hologram recording carrier according to the embodiment of the present invention;

FIG. 3 is a schematic fragmentary sectional view showing the hologram recording carrier according to another embodiment of the present invention;

FIG. 4 is an enlarged fragmentary plan view showing part of a row of marks on the hologram recording carrier according to the embodiment of the present invention;

FIG. 5 is an enlarged fragmentary plan view showing part of a row of marks on the hologram recording carrier according to the embodiment of the present invention;

FIG. 6 is an enlarged fragmentary plan view showing part of rows of marks on the hologram recording carrier according to the embodiment of the present invention;

FIG. 7 is a block diagram showing schematically the configuration of a hologram apparatus that records or reproduces information into or from the hologram recording carrier according to the embodiment of the present invention;

FIG. 8 is a schematic perspective view showing schematically a pickup of the hologram apparatus that records or reproduces information into or from the hologram recording carrier according to the embodiment of the present invention;

FIG. 9 is a plan view showing a photo-detector of the pickup of the hologram apparatus that records or reproduces information into or from the hologram recording carrier according to the embodiment of the present invention;

FIG. 10 is a graph explaining a position error signal for detecting a positioning mark of the hologram recording carrier according to the embodiment of the present invention;

FIG. 11 is an enlarged fragmentary plan view showing part of a row of marks on the hologram recording carrier according to another embodiment of the present invention;

FIG. 12 is an enlarged fragmentary plan view showing part of a row of marks on the hologram recording carrier according to another embodiment of the present invention;

FIG. 13 is a plan view showing part of a row of marks on the hologram recording carrier according to another embodiment of the present invention;

FIG. 14 is a schematic perspective view showing schematically a pickup of a hologram apparatus that records or reproduces information into or from the hologram recording carrier according to another embodiment of the present invention;

FIG. 15 is an enlarged fragmentary plan view showing part of a row of marks on the hologram recording carrier according to another embodiment of the present invention;

FIG. 16 is an enlarged fragmentary plan view showing part of rows of marks on the hologram recording carrier according to another embodiment of the present invention; and

FIG. 17 is an enlarged fragmentary plan view showing part of rows of marks on the hologram recording carrier according to another embodiment of the present invention.

### DETAILED DESCRIPTION OF THE INVENTION

Embodiments of the present invention will be described below with reference to the drawings.

### <Hologram Recording Carrier>

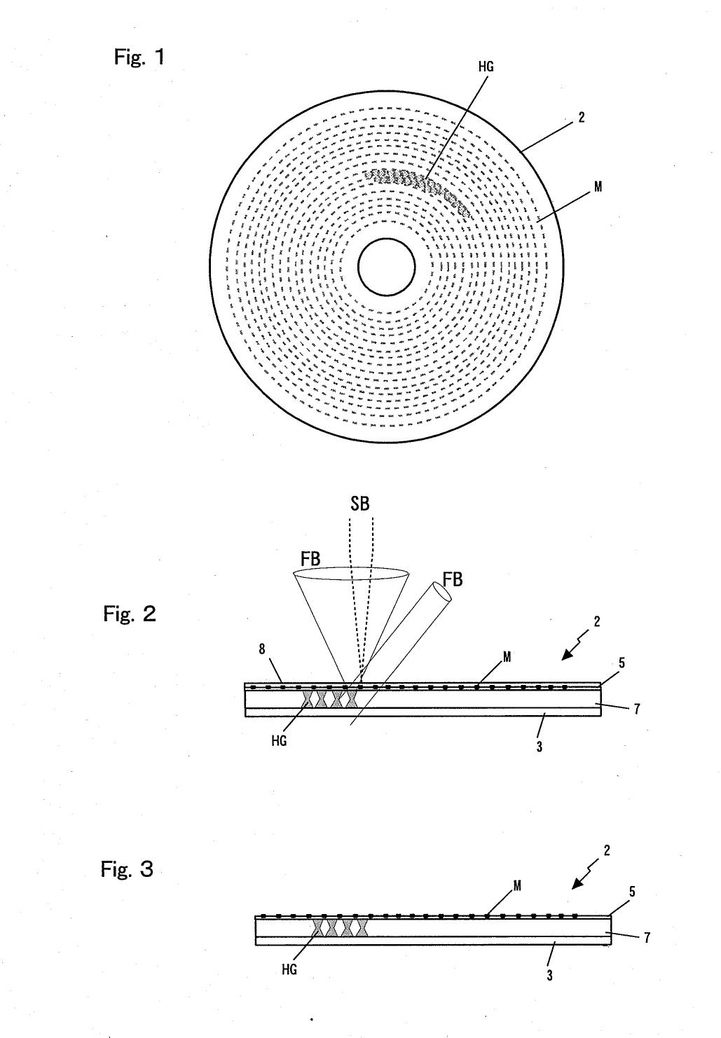

FIG. 1 shows a disc-shaped hologram recording carrier 2, an example of the present embodiment, which information is recorded into or reproduced from by irradiating light. In the hologram recording carrier 2 in which holograms HG are stored, multiple marks M are recorded beforehand so as to form multiple mark rows in concentric circles.

As shown in FIG. 2, the hologram recording carrier 2 comprises a hologram recording layer 7, a servo layer 5, and a protective layer 8 laid one on top of another on a substrate 3. The hologram recording carrier 2 has the hologram recording layer 7 that stores an optical interference pattern by a hologram recording beam formed of coherent reference light and signal light as a hologram (diffraction grating) therein, and the servo layer 5 laid on top of the layer 7 in a film thickness direction. As shown in FIG. 3, the protective layer 8 may be omitted from the hologram recording carrier 2.

The hologram recording layer 7 is made of photorefractive material, hole burning material, photochromic material, or the like as photosensitive material sensitive to the wavelength of the hologram recording beam (reference light and signal light). The material of the hologram recording layer 7 is selected from materials not sensitive to the wavelength of a servo beam SB.

The substrate 3 is made of, e.g., glass, or plastic such as polycarbonate, amorphous polyolefin, polyimide, PET, PEN, or PES, or ultraviolet curable acrylic resin, but not limited to any.

The protective layer 8 is made of light transmissive material and in charge of flattening the laminated structure and protecting the hologram recording layer, etc.

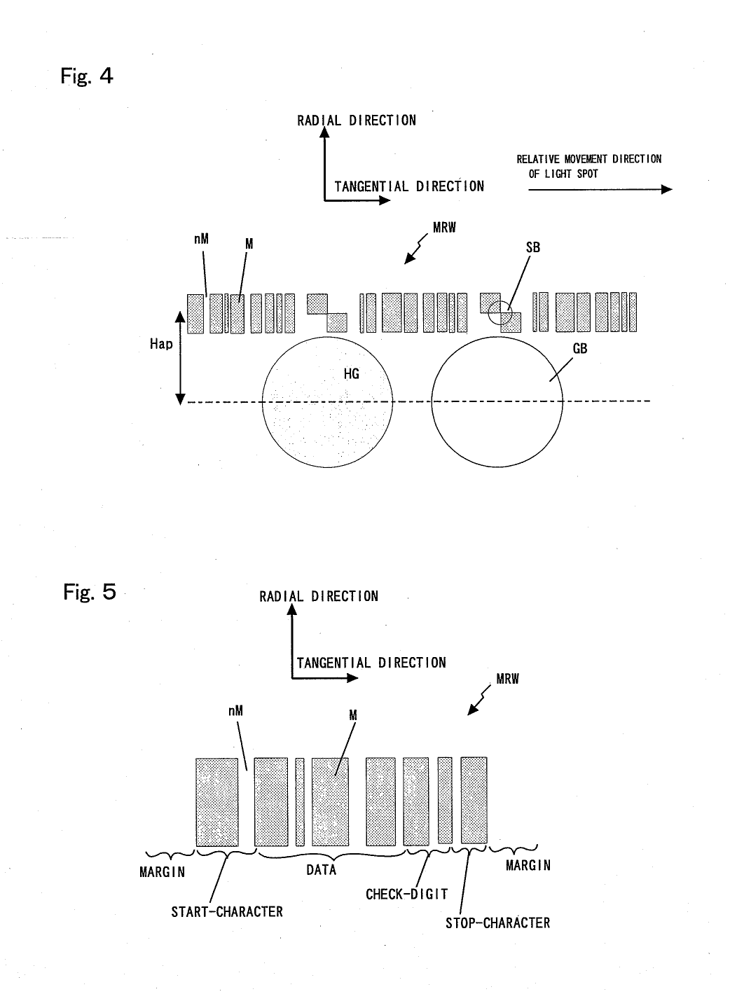

Multiple marks Mare recorded beforehand in the servo layer 5 laid on top of the layer 7 in a film thickness direction. The marks M are formed of material hardly sensitive to the hologram recording beam. For example, the mark M is a wavelength selectively reflective film having reflectance to only the wavelength of the servo beam SB. As shown in FIG. 4, the marks M form a line as multiple mark rows MRW that is parallel to the relative movement direction of the signal light GB light spot of the hologram recording beam irradiated. The multiple mark rows MRW extending apart from each other, not intersecting, in the servo layer 5 can be formed by printing or the like.

Recording areas to record holograms (a book) and the mark rows MRW are arranged at respective different positions in a plane of the hologram recording carrier 2. Hence, the optical axis of the servo beam SB is a predetermined distance Hap apart from the optical axis of the signal light GB such that the light spot of the servo beam SB is formed offset from the optical axis of the signal light GB as shown in FIG. 4.

The mark row MRW is formed of an arrangement of marks M of a high reflectance and non-marks nM (non-raised parts) that alternate with the marks M. Each of the marks M in the mark row MRW has a shape longer in a direction perpendicular to the relative movement direction of the irradiated servo light spot than in a direction parallel thereto. When detecting light reflected by the mark row MRW with use of a photo-detector, because the servo light spot moves across the marks M formed like a bar code, the amount of reflected light varies according to the black and white, or light and dark, of the mark row MRW, i.e., a mark code. Hence, the variation in the amount of reflected light is converted into an electrical signal and obtained.

As shown in FIG. 4, the mark row MRW as the mark code may be in the format of start-character/data/check-digit/stop-character in that order with spaces (margins) provided at opposite ends of the mark code.

If the margin is not sufficient, the reading may become unstable. This is because it is difficult to identify the start and end positions. The start-character and stop-character are characters denoting the start and end of data, such as “*”, “a”, “b”, “c”, or “d”. In the data, mark patterns for characters (numbers, alphabet letters, etc.) denoting information are arranged in succession from the read start side. For example, the data may denote address data of “0123” when they are arranged in that order. The check-digit is a numerical value calculated to check whether a read error exists and is added immediately after the mark code data. The length of the mark row MRW, i.e. the mark code, is preferably taken to include the margins at opposite ends. The width of the mark code is desirably set to be long in radial direction because the mark code moves in radial direction when disc eccentricity or the like occurs. If the width of the mark code is small, the servo beam may move outside the mark code, and thus stable reading cannot be performed. The width is preferably set at 15% or more of the length of the mark code. As to the thicknesses of the marks and non-marks that are minimum units forming the mark code in a direction parallel to the relative movement direction of the servo light spot, the mark code can be formed of a combination of, e.g., thin and thick marks NB, WB and thin and thick non-marks NS, WS. Their thickness ratios may be set as follows: NB:WB=NS:WS=1:2 to 1:3.

As the data of the mark row MRW, there can be named an address mark indicating the address of an area of the hologram recording layer to record a hologram, and relation marks indicating various information related thereto (such as compression method information, material information, and information on laser power, record wavelength, or the like).

The mark row MRW is also used for the control of at least tracking servo of an object lens for irradiating a light beam. Where the substrate 3 is a circular plate, in order to enable tracking servo control, mark rows MRW may be formed on the substrate concentrically about the substrate center, or spirally, or in a plurality of segmented spiral arcs.

An example of the disc-shaped hologram recording carrier (FIG. 1) will be described where as the data of each mark row MRW, an address mark indicating the address of an area of the hologram recording layer to record a hologram is recorded beforehand.

### Example 1

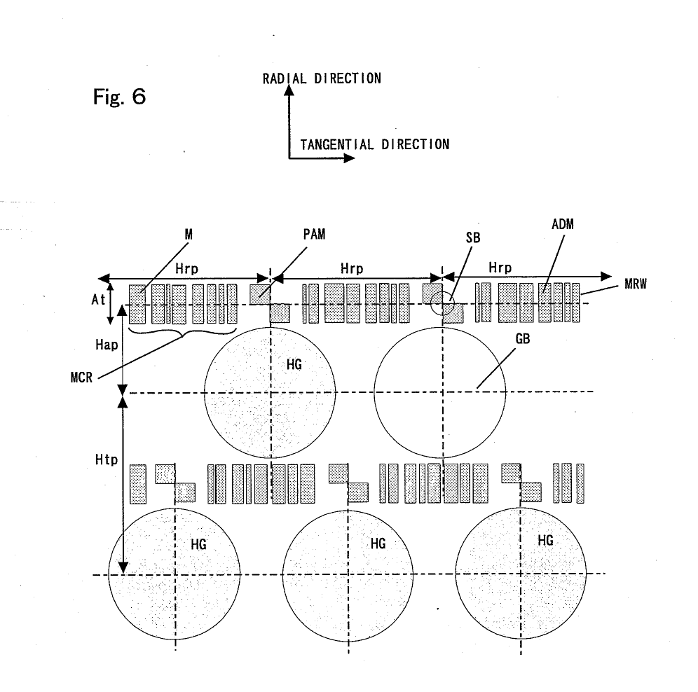

A mark code region MCR formed of a mark row holds information indicating the address of a book. In the servo layer 5, another layer than the hologram recording layer 7, address marks ADM (mark code regions MCR) and positioning marks PAM are recorded beforehand as shown in FIG. 6.

The address mark ADM is located at a position where the hologram recording beam (signal light GB) does not pass through, and one mark code region MCR and one adjacent positioning mark PAM form a pair.

The positioning mark PAM has such a shape that the position in radial and tangential directions can be detected when the servo beam SB traces a row of marks on the servo layer 5. For example, as shown in FIG. 6, the positioning mark PAM formed of four equal light and dark squares into which a square is divided is shaped such that when the servo beam SB is located at the center of the positioning mark PAM, the dark squares are located at diagonally located quadrants of the light spot.

Meanwhile, the address mark ADM is formed of marks M that are longer in a radial direction of the hologram recording carrier than in a tangential direction. The length At (in radial direction) of the mark M is set to be large enough that the light spot of the servo beam SB does not stick out of the address mark ADM if the eccentricity of the hologram recording carrier occurs when the light spot is located at the center.

For the disc, the length “At” in radial direction of the mark M is determined as follows. With a hologram recording carrier having an eccentricity amount Dc, when the servo beam SB moves one book record interval Hrp in tangential direction on a disc circumference of a reproduction radius r where mark rows MRW are to be formed, letting ΔDc be a perturbation eccentricity amount on the mark M that is a deviation from the reproduction radius r, the perturbation eccentricity amount ΔDc is expressed as ΔDc=Dc/(2*π*r/Hrp). Hence considering the inward and outward of the disc circumference of the reproduction radius r, the length At in radial direction of the mark M is expressed as At≧2*ΔDc+R, where R is the length in radial direction of the servo beam SB. Thus, the length of the mark M is preferably set at a value satisfying At≧2*Dc/(2*π*r/Hrp)+R=Dc*Hrp/π*r+R.

The total length of the pair of the mark code region MCR and the positioning mark PAM is equal to the book record interval Hrp in tangential direction (optical disc rotational direction) of the hologram recording carrier as shown in FIG. 6. Further, pairs of the address mark ADM and the positioning mark PAM extending in tangential direction are arranged in radial direction at intervals equal to a book record interval Htp similarly.

As such, two adjacent positioning marks PAM in tangential direction of the hologram recording carrier are formed at an interval equal to the book record interval Hrp. Rows of pairs of the address mark ADM and the positioning mark PAM are arranged like optical disc tracks in radial direction of the hologram recording carrier. Thus, the track pitch, i.e., the interval between adjacent ones in radial direction of these mark rows is equal to the book record interval Hrp in radial direction. The address marks ADM of these mark rows are determined in interval and width such that the hologram recording beam FB does not pass through them. Hence it does not happen that these marks give noise or the like to the recording/reproducing beam. If the hologram recording beam FB overlaps the address mark ADM somehow, no problem occurs, because it is made of material sensitive to only the servo beam SB. Note that the book record intervals Hrp and Hrp in tangential and radial directions may be equal or may not be equal.

Where the hologram recording carrier is in an optical disc shape, eccentricity may occur in the optical disc. The width At in radial direction of the mark code region MCR is set to be wide enough that the light spot of the servo beam SB does not stick out of it even if the hologram recording carrier is eccentric.

### <Hologram Apparatus>

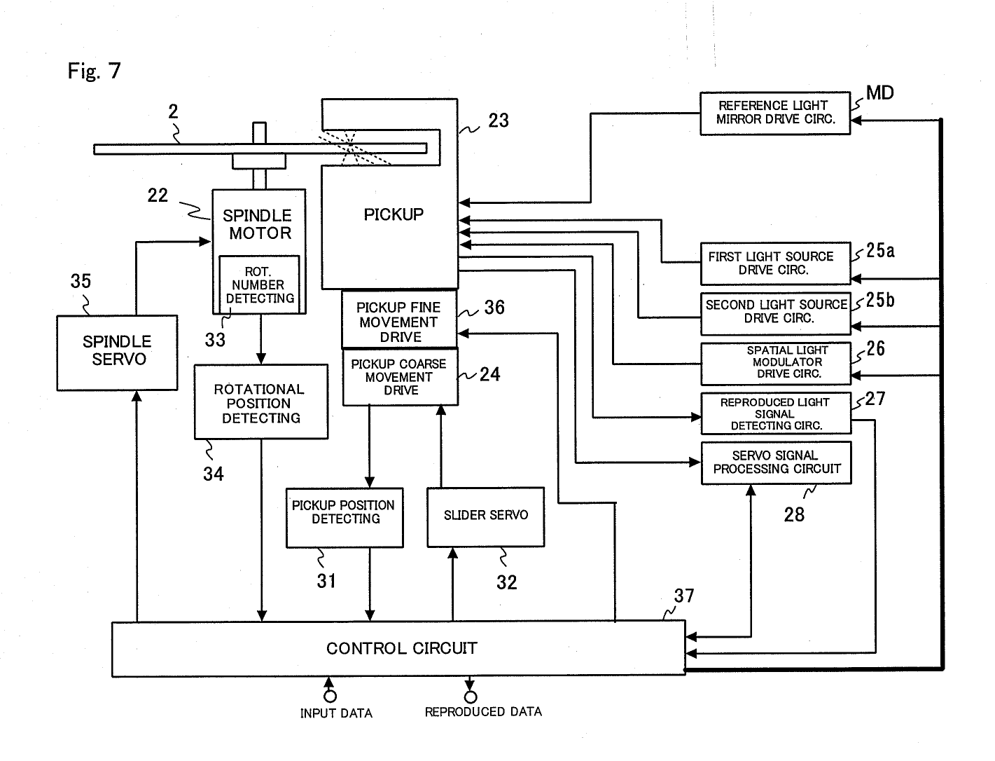

FIG. 7 shows schematically an example configuration of an angle multiplexing hologram apparatus that records or reproduces information into or from a hologram recording carrier to which the present invention is applied.

The hologram apparatus of FIG. 7 comprises a reference light mirror drive circuit MD, a spindle motor 22 to rotate a disk of a hologram recording carrier 2 on a turntable, a pickup 23 to read out a signal via a light beam from the hologram recording carrier 2, a pickup coarse movement drive unit 24 to hold and move the pickup in a radial direction, a first light source drive circuit 25a, a second light source drive circuit 25b, a spatial light modulator drive circuit 26, a reproduced light signal detecting circuit 27, a servo signal processing circuit 28, a pickup position detecting circuit 31 connected to the pickup coarse movement drive unit 24 to detect a position signal of the pickup, a slider servo circuit 32 connected to the pickup coarse movement drive unit 24 to supply a predetermined signal thereto, a rotational number detecting unit 33 connected to the spindle motor 22 to detect a rotational number signal of the spindle motor, a rotational position detecting circuit 34 connected to the rotational number detecting unit to produce a rotational position signal of the hologram recording carrier 2, and a spindle servo circuit 35 connected to the spindle motor 22 to supply a predetermined signal thereto.

The hologram apparatus has a control circuit 37, which is connected to the reference light mirror drive circuit MD, the first light source drive circuit 25a, the second light source drive circuit 25b, the spatial light modulator drive circuit 26, the reproduced light signal detecting circuit 27, the servo signal processing circuit 28, the pickup position detecting circuit 31, the slider servo circuit 32, the rotational number detecting unit 33, the rotational position detecting circuit 34, and the spindle servo circuit 35. The control circuit 37 performs coarse and fine movement servo control, reproducing position (position in radial and tangential directions) control, and the like for the pickup via these drive circuits based on pre-selected signals. The control circuit 37 is constituted by a microcomputer incorporating various memories, controls the entire apparatus, and generates various control signals according to operation inputs by a user through an operation unit (not shown) and to the current operating status of the apparatus. Further, the control circuit 37 is connected to a display unit (not shown) to display the operating status and the like for the user.

The control circuit 37 performs processes such as the encoding of externally inputted data to be hologram recorded and supplies signals to the spatial light modulator drive circuit 26 to control the hologram recording sequence. The control circuit 37 performs demodulation and error correction on a signal from the reproduced light signal detecting circuit 27, thereby retrieving data recorded in the hologram recording carrier. Further, the control circuit 37 decodes the retrieved data, thereby reproducing information data and outputting it as reproduced information data.

Moreover, the control circuit 37 performs processes such as the encoding of thumbnail information of content information (e.g., image data) obtained from hologram data to be recorded and of data related to the hologram data such as the compression method, encode/decode method, laser power, and recording wavelength at hologram recording. Then, the control circuit 37 performs hologram recording based on signals supplied from the servo signal processing circuit 28 using information of mark rows MRW recorded in the servo layer of the hologram recording carrier.

### <Optical Pickup>

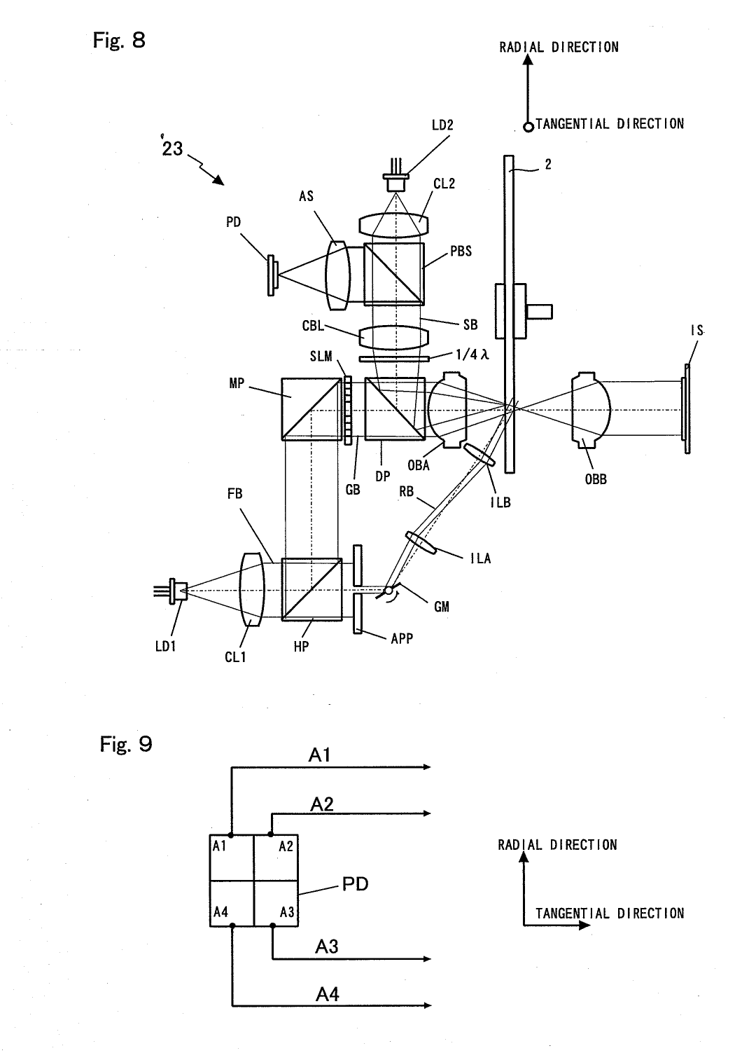

FIG. 8 shows schematically the configuration of the pickup 23 of this hologram apparatus. This pickup has a configuration where an optical system, e.g., a servo optical system, for detecting information of mark rows MRW is added to the pickup of a usual angle multiplexing hologram apparatus.

The pickup 23 consists mainly of a hologram recording/reproducing optical system, a servo optical system, and a common system.

The hologram recording/reproducing optical system comprises a first laser source LD1 for hologram recording/reproducing connected to the first light source drive circuit 25a, a first collimator lens CL1, a half mirror prism HP, a spatial light modulator SLM, an object lens OBA, an object lens OBB, a reproduced light signal detecting unit including an image sensor IS constituted by an array of charge-coupled devices (CCDs), complementary metal-oxide semiconductor devices (CMOSs), or the like and connected to the reproduced light signal detecting circuit 27, an aperture APP, a galvano mirror GM, and illumination lenses ILB and ILA of a 4f optical system. A pair of the object lenses OBA, OBB are arranged in a line such that their focal points coincide, and the spatial light modulator SLM and the image sensor IS are placed conjugate at focal positions on opposite sides of the pair. The hologram recording carrier 2 is positioned offset from the common focal point of the pair of object lenses OBA, OBB. The spatial light modulator SLM is, for example, a transmissive liquid crystal panel having a plurality of pixel electrodes divided in a matrix and has a function to electrically transmit or block the incident light on a per pixel basis. This spatial light modulator SLM is connected to the spatial light modulator drive circuit 26 and modulates the light beam so as to have a distribution based on to-be-recorded page data (an information pattern of two-dimensional data such as a bright and dark dot pattern on a plane) from the spatial light modulator drive circuit 26, thereby producing the signal light.

The servo optical system comprises a second laser source LD2, a second collimator lens CL2, a polarizing beam splitter PBS, a converging lens CBL, a quarter-wavelength plate ¼λ, a detection lens AS, and a servo signal detecting unit including a photo-detector PD to perform servo control (movement in radial, tangential, and focusing directions) of the servo beam position (pickup position) relative to the hologram recording carrier 2. Further, the servo optical system is used to reproduce information of mark rows MRW from the servo layer 5.

The wavelength of the second laser source LD2 of the servo optical system is set to be different from the wavelength of the first laser source LD1 of the recording optical system. The servo beam SB is positioned offset from the optical axis of the signal light GB so as to be converged on the address mark ADM of the servo layer 5 by the object lens OBA converging the signal light GB. Reflected light of the servo beam SB reflected by the servo layer 5 passes through the object lens OBA of the servo optical system and is detected by the photo-detector PD. The photo-detector for detecting the positioning mark PAM is constituted by four divided light receiving elements.

A dichroic prism DP and the object lens OBA are part of the common system.

Further, the pickup 23 is provided with a pickup fine movement drive unit 36 for moving the object lens OB together with the pickup's housing in a direction parallel to its optical axis (focusing direction) and in a direction parallel to (tangential direction) and a direction perpendicular to the mark row MRW (radial direction).

The photo-detector PD of the servo signal detecting unit is connected to the servo signal processing circuit 28 and has, for example, light receiving elements for the control of movement of the servo beam in focusing, radial, and tangential directions respectively. Output signals of the photo-detector PD such as a mark signal RF, a focus error signal, and a tracking error signal are supplied to the servo signal processing circuit 28.

The servo signal processing circuit 28 generates drive signals from these error signals, which are supplied via the control circuit 37 to the pickup fine movement drive unit 36. The pickup fine movement drive unit 36 operates to finely adjust the pickup position. The pickup is finely driven to move the distances according to drive currents due to the drive signals in focusing, radial, and tangential directions, thereby displacing the position of the light spot irradiated on the hologram recording carrier. By this means, when being recorded, the position of the light spot relative to the moving hologram recording carrier is kept constant, thus securing a hologram forming time.

The control circuit 37 generates a slider drive signal based on the position signal from the operation unit or the pickup position detecting circuit 31 and a radial movement error signal from the servo signal processing circuit 28 and supplies this to the slider servo circuit 32. The slider servo circuit 32 makes the pickup 23 move according to a drive current due to the slider drive signal in a disc radial direction via the pickup coarse movement drive unit 24.

The rotational number detecting unit 33 detects a frequency signal indicating the current rotational frequency of the spindle motor 22 rotating the hologram recording medium 2 on the turntable and generates a rotational number signal indicating the spindle rotational number corresponding thereto to supply it to the rotational position detecting circuit 34. The rotational position detecting circuit 34 generates a rotational position signal and supplies it to the control circuit 37. The control circuit 37 generates a spindle drive signal and supplies it to the spindle servo circuit 35 to control the spindle motor 22, thereby rotationally driving the hologram recording carrier 2.

The operation of the hologram recording optical system is as follows.

Diverging light emitted from the first laser source LD1 is made by the first collimator lens CL1 to be a parallel beam, which is divided into two optical paths by the half mirror prism HP.

Light forking toward a mirror prism MP at the half mirror prism HP is then reflected by the prism MP and incident on the spatial light modulator SLM, where the light is spatially modulated according to page data into the signal light GB. The signal light GB passes through the dichroic prism DP where it is combined with light of the servo optical system, and is incident on the object lens OBA and then on the hologram recording carrier 2.

Meanwhile, the reference light RB is restricted in size by the aperture APP to a moderate diameter and reflected by the galvano mirror GM. The reflected reference light RB is incident on the 4f optical system of the illumination lenses ILB and ILA and intersects with the signal light GB in the hologram recording carrier 2. By rotating the galvano mirror GM by predetermined small angles and fixing it each time after rotation, the reference light RB is rotated about a point at which the galvano mirror GM and the reference light RB intersects and stopped repeatedly, thereby forming holograms HG (diffraction gratings) in an angle multiplexing manner in the hologram recording carrier 2 to record multiple holograms (a book) therein. After recording a book, the hologram recording carrier 2 is moved to record a book in another area. The galvano mirror GM is driven by the reference light mirror drive circuit MD controlling an actuator to turn its rotation shaft.

In the angle multiplexing scheme, when recording, by changing the angle of the reference light relative to the signal light by slight amounts, a different record information piece for each angle can be multiplex recorded in the same area in the hologram recording carrier. Generally, in a hologram apparatus of the angle multiplexing scheme, the so-called 4f optical system and the galvano mirror are used as a mechanism for changing the angle of the reference light irradiated onto a hologram recording carrier. As shown in FIG. 8, a plurality of 4f lenses are arranged in the optical path of the 4f optical system such that their focal points coincide, and the rotation shaft of the galvano mirror is positioned at the lens focal point on one end, and the recording layer of the hologram recording carrier 2 is positioned at the lens focal point on the other end (conjugate position).

When reproducing holograms, by putting the spatial light modulator SLM in a light blocking state, the irradiation of the signal light GB is stopped, and only the reference light RB is made incident at a given angle on the hologram recording carrier 2 to reproduce the signal light from a hologram, which is photoelectric converted into page data by the image sensor IS.

The operation of the servo optical system is as follows.

Diverging light emitted from the second laser source LD2 whose wavelength is different from that of the hologram recording beam FB is made by the second collimator lens CL2 to be a parallel beam as the servo beam SB, which passes through the polarizing beam splitter PBS and the converging lens CBL and is combined with light of the hologram recording optical system at the dichroic prism DP. The converging lens CBL of the servo optical system in combination with the object lens OBA causes the servo beam SB to converge into a light spot of a certain diameter on the servo layer 5 of the hologram recording carrier 2. This light spot does not necessarily need to be converged to the diffraction limit. Because the book recording area and the mark code region MCR for the address mark ADM are different in position in the plan view of the hologram recording carrier 2, the optical axis of the servo beam SB is positioned offset such that its light spot is formed offset from the optical axis of the signal light GB.

Light reflected from the servo layer 5 goes through the polarizing beam splitter PBS and detection lens AS of the servo optical system and is detected by the photo-detector PD. The hologram recording carrier 2 is moved in tangential direction (rotated) for each book recording. Through this movement, the signal of the mark code regions MCR can be detected, so that a book address at which to record can be found. Then, in order to find a place where to record a book, the positioning mark PAM is used. Positioning marks PAM are arranged at intervals equal to the between-book interval and have such a shape that by reading them with the servo beam SB, the positions can be determined.

The photo-detector PD consists of light receiving elements A1 to A4 having four equal light receiving faces divided into along radial and tangential directions for receiving the servo beam SB. The directions of the division lines are in a disc radial direction and in a direction parallel to the mark row MRW (tangential direction). The photo-detector PD is positioned such that when the servo beam SB is in focus, the reflected light spot is shaped in a circle with the intersection point of the division lines of the light receiving elements A1 to A4 as the center.

The servo signal processing circuit 28 generates various signals according to the output signals of the light receiving elements A1 to A4 of the photo-detector PD.

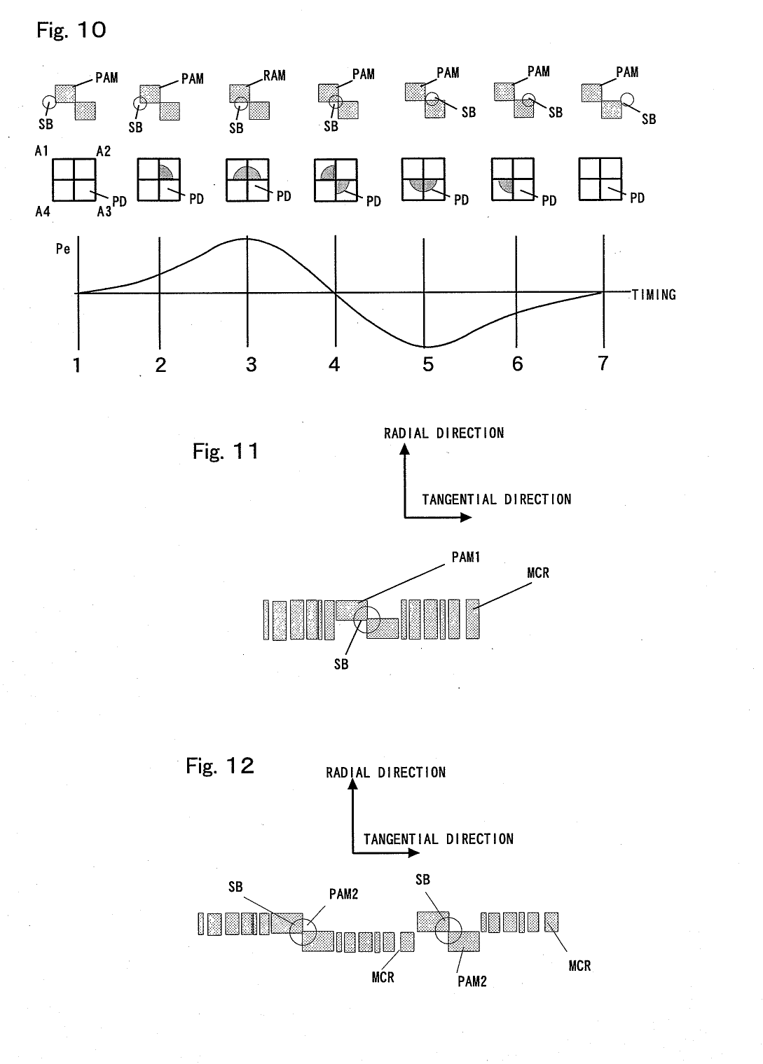

FIG. 10 shows the method of detecting a positioning mark PAM. The photo-detector PD of FIG. 9 is used to detect an error. When the light spot of the servo beam SB moving relatively in tangential direction comes across a positioning mark PAM, a quadrant of the photo-detector, i.e., the light receiving element A2 detects return light (timing 2). Further advancing, the light receiving elements A1, A2 detects it (timing 3). At the mark position, the light receiving elements A1, A3 detects it (timing 4). While the light spot of the servo beam SB moves away from the center of the mark, the light receiving elements opposite those detect the return light. Thus, letting A1 to A4 represent the outputs of the light receiving elements A1 to A4, by performing an operation of Pe=(A1+A2)−(A3+A4), a position error signal Pe is obtained which indicates the difference with the positioning mark PAM. The hologram recording carrier 2 or the pickup is moved in tangential direction of the hologram recording carrier 2 based on the position error signal Pe, and thus at an appropriate position where a book is to be recorded (the position of a positioning mark PAM), holograms can be recorded.

### (Variant of Example 1)

For making the mark code region MCR and the positioning mark PAM distinguishable in a way other than providing a blank (margin) between the mark code region MCR and the positioning mark PAM as in Example 1, example modified shapes of the address mark ADM and the positioning mark PAM will be shown.

As shown in FIG. 11, a positioning mark PAM1 is set to be longer in tangential direction than in radial direction. By this means, when only the light receiving elements A1, A2 of the photo-detector detect light, it can be determined that an address mark is about to come.

As shown in FIG. 12, markcode regions MCR are displaced alternately in ±radial directions for each between-book interval. By this means, when light receiving elements detecting light of the photo-detector switch from A1, A2 to A3, A4, it can be determined that an address mark is about to come.

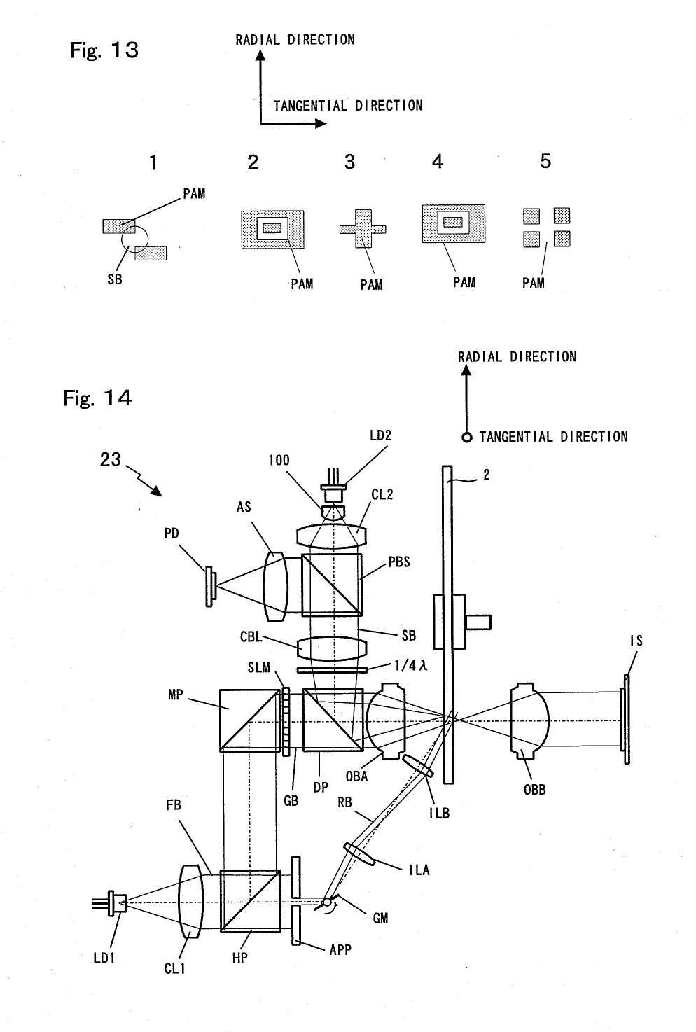

As shown in 1, 2, 3, 4, and 5 of FIG. 13, the positioning mark PAM need only be formed of light and dark shapes symmetrical in radial and tangential directions.

### Example 2

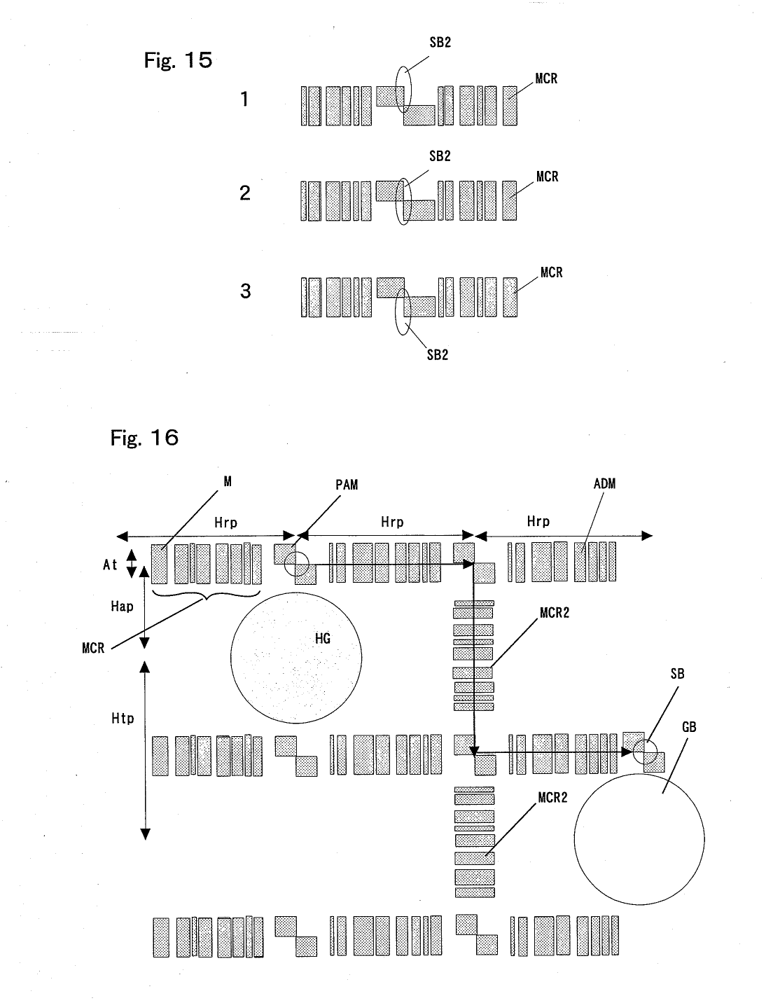

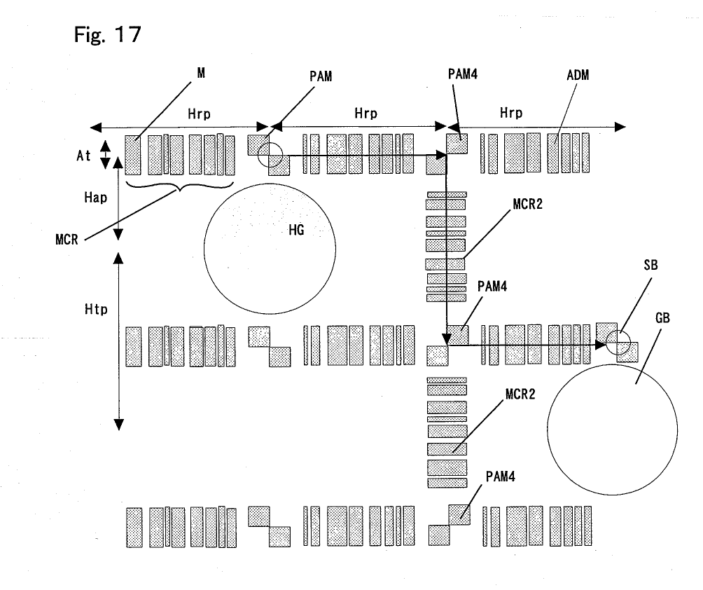

FIG. 14 shows schematically the configuration of a pickup 23 of Example 2. The pickup 23 is the same as in Example 1 of FIG. 8 except that astigmatism generating means (e.g., a cylindrical lens) 100 that shapes the servo beam SB so as to become longer in radial direction of the hologram recording carrier 2 is positioned between the first laser source LD1 and the first collimator lens CL1 of the servo optical system, the hologram recording optical system being the same. Because the servo beam SB2 is made longer in radial direction of the hologram recording carrier 2 by the optical element for generating astigmatism as shown in FIG. 15, the servo beam SB2 does not move outside the mark code region MCR or the positioning mark PAM even if the servo beam SB2 slightly deviates in radial direction (1 or 3 of FIG. 15) (due to eccentricity in the case of an optical disc) from its appropriate position (2 of FIG. 15) when the hologram recording carrier 2 moves in tangential direction. As a result, even if variation of the hologram recording carrier 2 or an error in the mechanism for moving the hologram recording carrier 2 occurs, good positioning can be executed, and hence books can be recorded at accurate intervals.

### Example 3

FIG. 15 shows schematically the configuration of a hologram recording carrier of Example 3, particularly the configuration of mark rows consisting of multiple marks formed in the servo layer. Example 3 is the same in the pattern of the mark code regions MCR and the positioning marks PAM as Example 1 shown in FIG. 6 except that mark rows MRW2 extending in radial direction are added. A second positioning mark PAM2 different in shape from the positioning mark PAM may be placed at the position where mark rows MRW2 (address marks ADM) in a line extending in radial direction and mark rows MRW in a line extending in tangential direction intersect. For example, as shown in FIG. 16, a second positioning mark PAM4 at the intersection point has a shape inverse in light/dark to that of the positioning mark PAM. With this configuration, hologram recording positions in radial and tangential directions can be detected.

Mark rows MRW in a radial line and mark rows MRW in a tangential line are arranged to intersect at a positioning mark PAM in tangential direction, and hence when the servo beam SB is moved in radial direction after positioned in tangential direction of the hologram recording carrier 2, an address in radial direction can be read from the mark row MRW2. Movement in radial direction is performed according to an algorithm similar to that for movement in tangential direction.

With the configuration shown in FIGS. 15, 16, by processing a signal detected by the servo beam SB, switching from movement in tangential direction to movement in radial direction can be achieved. Marks of addresses in radial direction may be located in a particular place or at regular intervals on the hologram recording carrier 2.

Although in the above embodiments description has been made taking the hologram recording carrier disc 2 as an example of a recording medium, the hologram recording carrier is not limited in shape to a disc but may be, for example, an optical card 20a of a rectangular parallel plate made of plastic, etc. In this optical card, mark rows MRW may be formed on a substrate, for example, spirally, in a plurality of spiral arcs, or concentrically about its center of gravity, or mark rows MRW may be formed in parallel lines on a substrate.

### EXPLANATION OF REFERENCE NUMERALS

2: Hologram recording carrier
3: Substrate
5: Servo layer
7: Hologram recording layer
8: Protective layer
22: Spindle motor
23: Pickup
24: Pickup coarse movement drive unit
25a: First light source drive circuit
25b: Second light source drive circuit
26: Spatial light modulator drive circuit
27: Reproduced light signal detecting circuit
28: Servo signal processing circuit
31: Pickup position detecting circuit
32: Slider servo circuit
33: Rotational number detecting unit
34: Rotational position detecting circuit
35: Spindle servo circuit
36: Pickup fine movement drive unit
37: Control circuit
HG: Hologram
MRW: Mark row
FB: Hologram recording beam
SB: Second light beam, Servo beam
M: Mark
LD1: First laser source
CL1: First collimator lens
HP: Half mirror prism
SLM: Spatial light modulator
IS: Image sensor
LD2: Second laser source
CL2: Second collimator lens
PBS: Polarizing beam splitter
¼λ: Quarter-wavelength plate
AS: Detection lens
PD: Photo-detector
DP: Dichroic prism
OBA, OBB: Object lens

1. A hologram recording carrier that information is recorded into or reproduced from by irradiating light, comprising:
a hologram recording layer to store an optical interference pattern by a coherent hologram recording beam as a hologram therein; and
a servo layer laid on top of said hologram recording layer in a film thickness direction, multiple marks being recorded beforehand on said servo layer,
wherein said multiple marks form lines as multiple mark rows extending in a direction parallel to a relative movement direction of a light spot of said hologram recording beam irradiated on said hologram recording carrier,
wherein positioning marks having a shape different from that of said marks are placed between ones of said mark rows in line in said direction parallel to the relative movement direction of said light spot at intervals equal to a recording interval of a plurality of said holograms,
wherein said hologram recording interval is equal to a recording interval of angle multiplexed hologram groups, and
wherein said mark rows each include an address mark.

2. A hologram recording carrier according to claim 1, wherein each of said marks has a shape longer in a direction perpendicular to said relative movement direction of said light spot than in said direction parallel thereto.

3. (canceled)

4. A hologram recording carrier according to claim 1, wherein an interval of adjacent ones of said mark rows in a direction perpendicular to the relative movement direction of said light spot is equal to a recording interval of a plurality of said holograms.

5. A hologram recording carrier according to claim 1, wherein between adjacent ones of said mark rows in a direction perpendicular to the relative movement direction of said light spot, mark rows each formed of multiple marks forming a line in said perpendicular direction are respectively placed, along which said light spot relatively moves.

6. A hologram recording carrier according to claim 1, wherein an identifying mark is placed at an end of said mark row formed of multiple marks forming a line in said perpendicular direction between adjacent ones of said mark rows in said perpendicular direction.

7. A hologram apparatus for a hologram recording carrier that hologram information is recorded into or reproduced from by irradiating light and has a hologram recording layer to store an optical interference pattern by a coherent hologram recording beam as a hologram therein, and a servo layer laid on top of said hologram recording layer in a film thickness direction, multiple marks being recorded beforehand on said servo layer, wherein said multiple marks form lines as multiple mark rows extending in a direction parallel to a relative movement direction of a light spot of said hologram recording beam irradiated on said hologram recording carrier,
which performs servo control to converge a light spot on said mark on said servo layer and read information of said mark from the return light, thereby making said light spots follow movement of said hologram recording carrier and at the same time, controls a relative position relationship between said hologram recording carrier and said light spots,
wherein positioning marks having a shape different from that of said marks are placed between ones of said mark rows in line in said direction parallel to the relative movement direction of said light spot at intervals equal to a recording interval of a plurality of said holograms,
wherein said hologram recording interval is equal to a recording interval of angle multiplexed hologram groups, and
wherein said mark rows each include an address mark.

8. A hologram apparatus according to claim 7, wherein said light spot on said servo layer has a shape longer in a direction perpendicular to said relative movement direction of said light spot than in said direction parallel thereto.
